(19) United States
(12) Patent Application Publication
(10) Pub. No.: US 2013/0076158 A1
(43) Pub. Date: Mar. 28, 2013

(54) Magnetic Fluid Power Generator Device

(71) Applicant: Susan MOTISSE, Burleigh Heads (AU)

(72) Inventor: Susan MOTISSE, Burleigh Heads (AU)

(21) Appl. No.: 13/244,484

(22) Filed: Sep. 25, 2011

(51) Int. Cl. H02K 44/00

(52) U.S. Cl. 310/11

(57) ABSTRACT

A device for converting thermal energy to electrical energy by moving magnetised ferrofluid or magnetic nanoparticle fluid through a specially-shaped hermetically sealed conduit coiled with insulated conducting wires. The moving fluid creates a changing magnetic flux through the coils. Usable current is generated in the induction circuit. The conduit carrying the magnetic fluid is coiled in a special shape around a shaped magnet or magnet assembly with plates. Convection currents occur in the fluid.

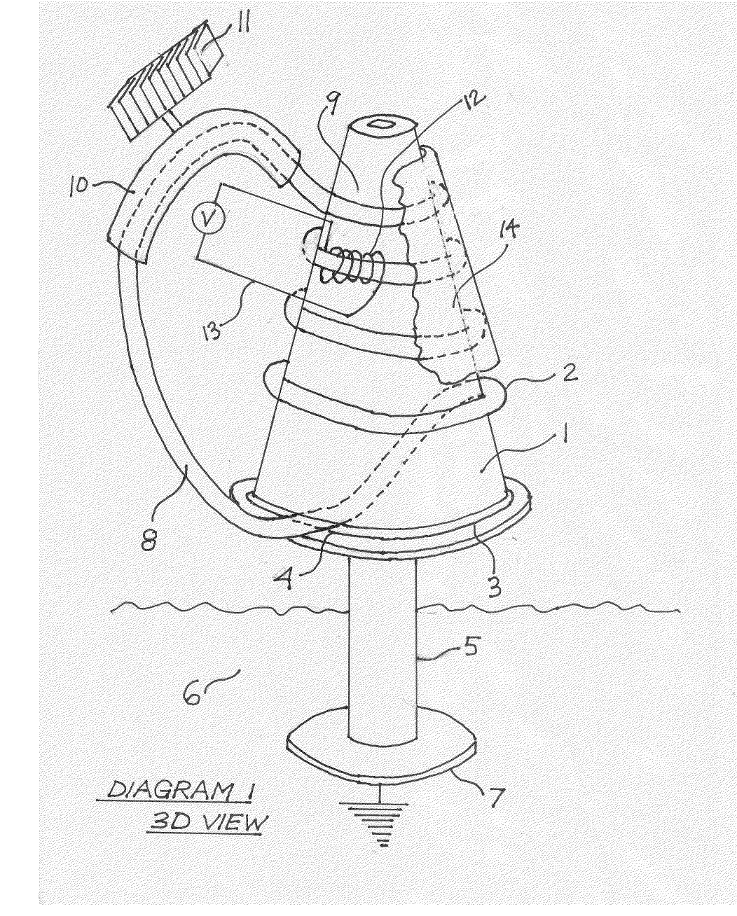

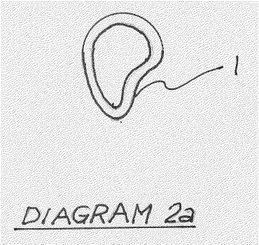

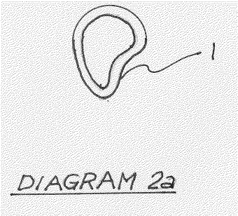

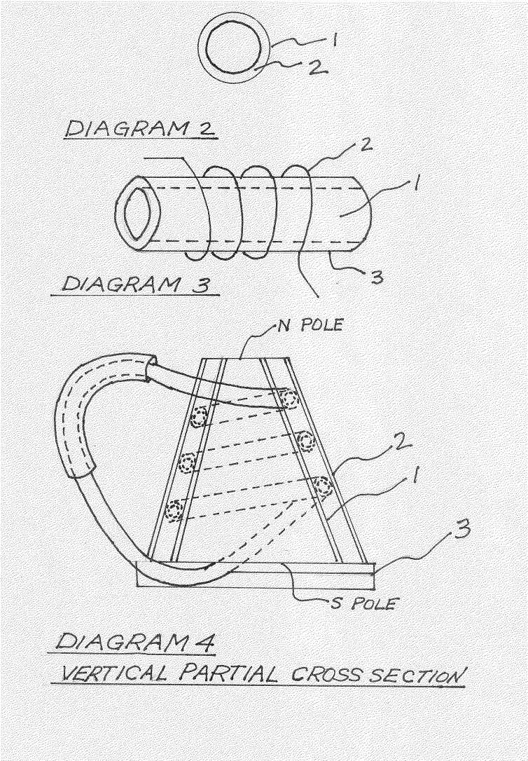

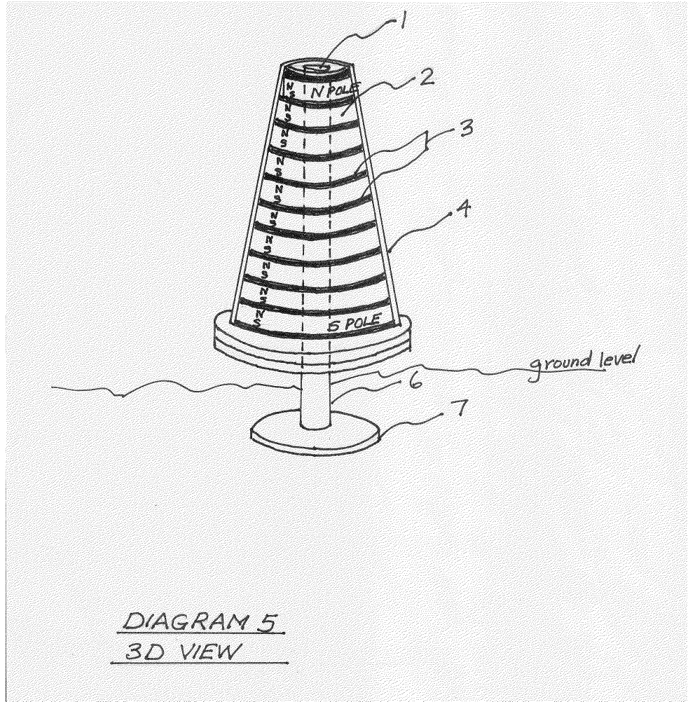

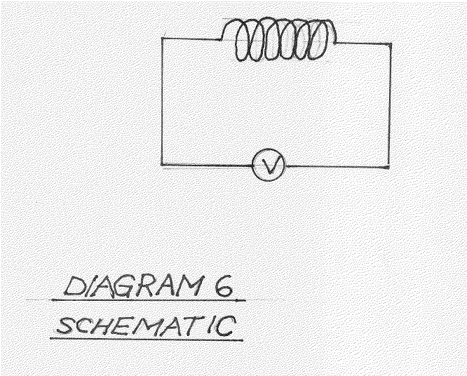

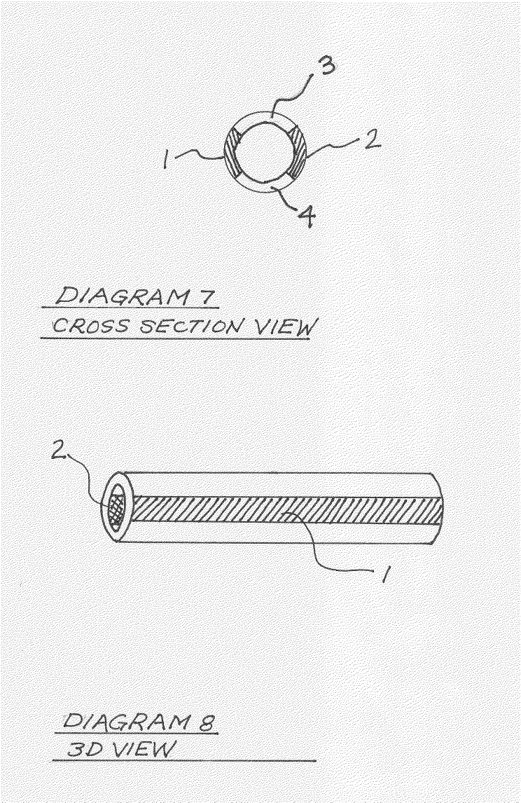

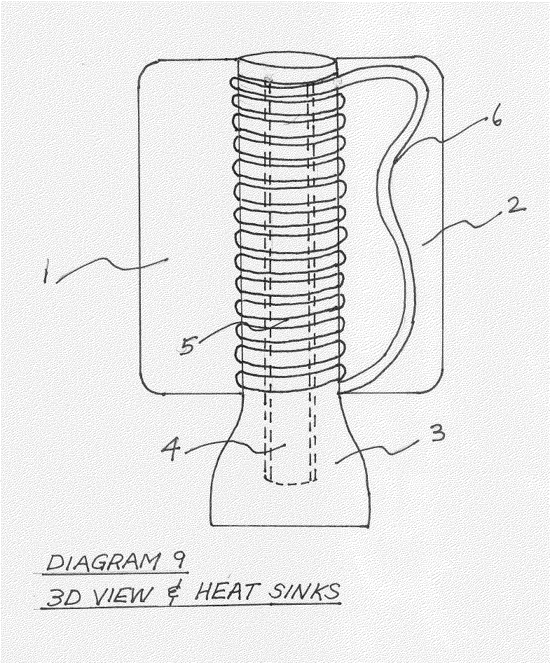

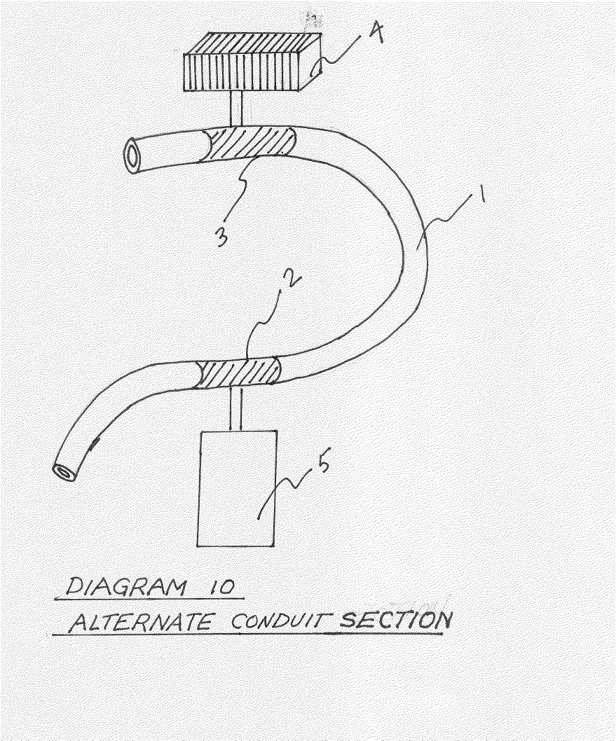

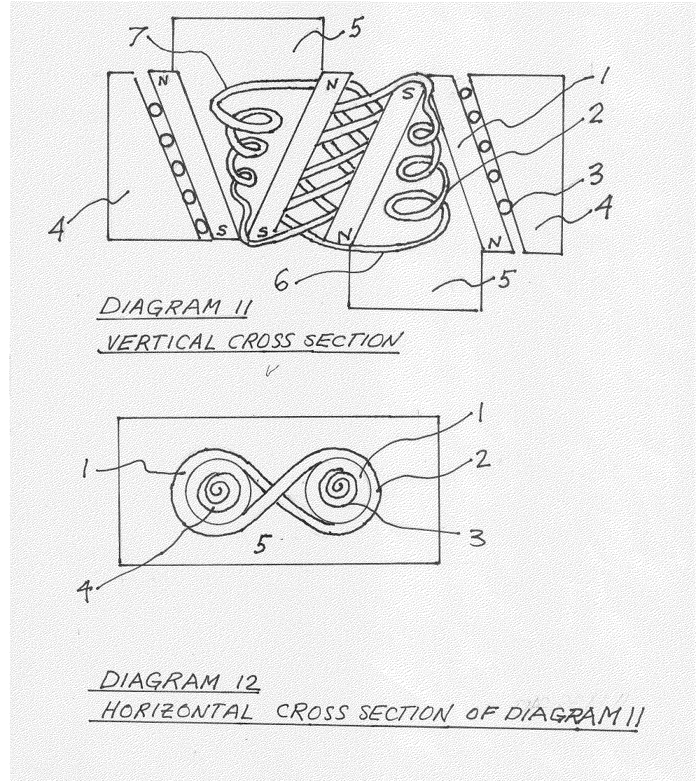

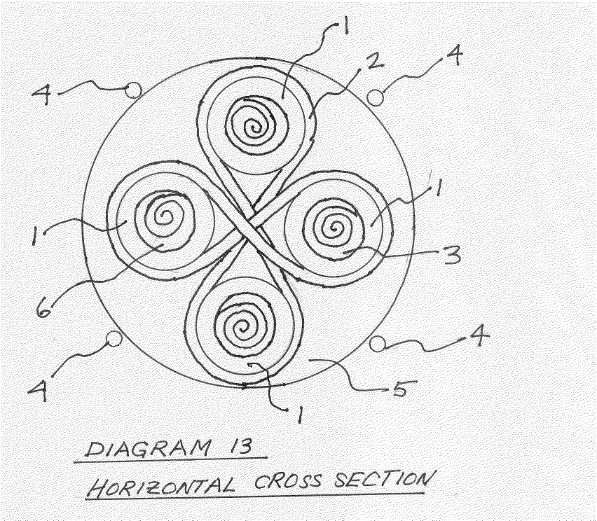

### BACKGROUND

This invention relates to an electric generator based on flowing magnetic ferrofluid or magnetic nanoparticle fluid. This magnetised fluid is contained in a conduit and moves through coils of insulated copper thereby generating usable current. The idea was to make an inexpensive power generator with no moveable solid mechanical components driven by a temperature differential that required no pump and used the sun as the heat source and the earth as a heat sink that could eventually eliminate the need for fossil fuels to generate electricity. The idea was to contain the magnetised ferrofluid in a closed circuit and to provide a device which is simple to construct, inexpensive, non-polluting, non-destructive to the earth and easy to manufacture. Another idea was to allow the ferrofluid to travel on a continually curved surface and thereby increase the spin of the magnetic dipoles of the ferrofluid or magnetic nanoparticles. A diamagnetic material is strategically placed in the conduit or around the conduit or in the material of which the conduit is made to increase repulsion of magnetic dipoles and therefore assist in increasing their kinetic energy. These objectives are attained in the invention described here in and will be useful for a magnetic fluid power generator and also as a power source for micro and nano electromagnetic systems. The present invention is demonstrated by providing 4 embodiments of a temperature and magnetically driven magnetic nano particle generator. The different embodiments show the paths of the magnetic ferrofluid travelling through a constantly curving surface; the said embodiments also show an additional number of magnets, magnetic assemblies or source of magnetising the fluid. References are:

PATENTS
4064409
5632093
6489694
6504271
6628017
6982501
7061129
7095143
7105935
7745962

4064409 This patent utilises flow of magnetised ferrofluid through a temperature difference.

It is different from mine because: it uses venturi action, the ferrofluid goes into a reservoir; in my invention there is no reservoir for the ferrofluid and therefore no disruption to the fluid flow. My invention has no angular configuration in conduit where fluid flows; in my invention the ferrofluid moves continuously through a magnetic field; in my invention the magnetic field distribution is different; the path of motion of the magnetic particles is different and temperature differential is applied differently; in my invention the conduit has a special configuration; in my invention the conduit is also hermetically sealed and contains paramagnetic or magnetic nanoparticle fluid; in my invention there is no vapour stage of magnetic nanoparticle fluid

5632093—mechanical vibrations are converted into electric energy; in my invention no external vibrations are required

6489694—external movement of tire causes a change in mechanical form; in my invention there is no external movement

7105935—in my invention there is no external pump; in my invention vortex generation is induced by the shape and configuration of the conduit, by the shape and position of the heat sink and heat source, as well as the shape of the conduit carrying ferrofluid or magnetic nanoparticles fluid.

### SUMMARY

The main objective of this invention is to provide a method of generating electrical power. The system is comprised of a closed loop of conduit carrying ferrofluid or nanomagnetic particle fluid. The ferrofluid moves by convection currents which are driven by a temperature differential. The convection currents are changed by the application of a magnetic field positioned to optimise the movement of the ferrofluid or nanomagnetic particle fluid. The movement of the magnetic dipoles within the ferrofluid changes the flow pattern of the convection currents. The conduit is wrapped with insulated copper conducting wire forming part of the induction circuit. As the ferro fluid moves it produces a time-varying magnetic flux through the coil forming part of the induction circuit where usable current is produced. The conduit forms a closed circuit and in the first embodiment the inside diameter of the conduit remains the same in the closed circuit loop. The conduit is hermetically sealed. The ferrofluid or nanomagnetic particle fluid is heated by a heat source such as the sun, atmosphere or water and is cooled by a heat sink such as the earth, ice or water. The conduit is arranged in a helicoidal shape around the cool conducting cone surrounding the magnet and then is positioned under the cool plates under the magnet and then the conduit moves in a curved path toward the heat sink. In this embodiment the conduit has the same internal diameter throughout. The conduit is surrounded by a conductor near the heat source before it spirals around the cones again. Another objective of this invention is to optimise the flow pattern of the ferrofluid or nano magnetic particle fluid by utilising shaped conduits; by utilising more than one magnet or magnet assembly; by utilising curved surfaces; by utilising a weaving of the conduit around more than one magnet; by utilising different shaped magnets; by utilising different cross-section of conduit; by utilising different cross-sectional variation of the conduit along its length.

### EXPLANATION OF DIAGRAMS

Diagram 1 shows one embodiment of the invention. Diagram 1 part 1 shows a cone-shaped conductor as shown in Diagram 5 part 4 placed around the outside surface of a magnet as shown in Diagram 5 part 2. The conical conductor is then wrapped with a non-conducting conduit in a helicoidial configuration as shown in Diagram 1 part 2. The last coil of the conduit moves under the cool magnet and conducting plate as shown in Diagram 1 part 3. The coil is touching the conducting plate and may be encased in a conducting material at location shown in Diagram 1 part 4. The conducting material touching or encasing the conduit is connected to a cylindrical conductor Diagram 1 part 5 which leads to the earth or a heat sink as shown in Diagram 1 part 6. A conductor as shown in Diagram 1 part 7 maximises the surface area exposed to the cool body or cool earth. The conduit is bent to emerge from the heat sink in a curved path as shown in Diagram 1 part 8. The conduit then passes into a sleeve (Diagram 1 part 10) which is a conductor which absorbs heat from the heat source ins

Diagram 1 part 11 as shown. The conduit then is wrapped around the top part of the cone shaped conductor in Diagram 1 part 9 before spiralling down the cone again. The conduit is filled with ferrofluid or a magnetic nano particle fluid and hermetically sealed. Diagram 1 part 12 shows the conduit wrapped with insulated conducting wire as part of the induction circuit as shown in the Diagram 1 part 13 and also in schematic Diagram 6.

The shape of the conduit in Diagram 1 is shown to be circular as shown in Diagram 2 part 1 which is a cross-section of the conduit. Diagram 2 part 2 shows the material of the conduit.

Diagram 2a part 1 shows another possible cross-section of the conduit.

Diagram 3 shows a 3D view of the conduit length wise where Diagram 2 part 2 is the insulated conductor wrapping the coil and part of the induction circuit.

Diagram 2 part 1 contains ferrofluid or magnetic nanoparticles. Diagram 2 part 3 shows the shape of the conduit.

Diagram 4 is a partial vertical cross-section view of the coils of the conduit. Diagram 4 part 1 as well as Diagram 5 part 4 shows a conductor cone which is on the outside of the magnet or magnet assembly. Diagram 4 part 2 shows a conductor cone on the outside of the conduit. Diagram 4 part 3 shows conducting plates or conductive encasement.

Diagram 5 is a partial 3D view of the arrangement of the magnets. Diagram 5 part 4 shows the conical conductor surrounding the magnet assembly. Diagram 5 parts 3 show conducting plates between the magnets. A cylindrical conductor passes through the centre of the magnets as shown in Diagram 5 part 1. The magnet rests on conducting plates (not shown to scale) which are attached to the cylinder as shown in Diagram 5 part 6. This cylinder leads to a plate in the ground as shown in Diagram 5 part 7.

Diagram 6 is schematic of the induction circuit.

Diagram 7 shows an alternate cross-section of conduit made up of conducting material Diagram 7 part 1 & 2 and made up of insulating material Diagram 7 part 3 & 4.

Diagram 8 shows a 3D view of a tubular cylinder that maximises heat transfer into the heat sink. The conducting material is located as shown in Diagram 8 part 1 & 2.

Diagram 9 is an additional embodiment of my invention. Diagram 9 parts 1 & 2 show the heat source which encompasses the outside edges of the conduit. Diagram 9 parts 3 & 4 show the heat sink which is liquid and is included in the centre of the cylinder through the magnets. Diagram 9 part 5 shows the thermally conductive liquid in another portion of the tube.

Diagram 10 is an alternate conduit section. Diagram 10 parts 2 & 3 show the tubular conductors placed in line with the conduit and having the same internal diameter of the conduit so as to not cause any disruption of fluid flow. Diagram 10 part 1 shows a section of the conduit which is connected to the rest of the conduit spiralling around the magnet. Diagram 10 part 4 shows the heat source. Diagram 10 part 5 shows the heat sink.

Diagram 11 shows vertical cross-section of another possible embodiment of my invention. Diagram 11 part 1 shows magnets. Diagram 11 part 2 shows conduit. Diagram 11 part 3 shows conduit. Diagram 11 part 4 shows heat source. Diagram 11 part 5 heat sink. Diagram 11 part 6 shows coil spirals down clockwise. Diagram 11 part 7 shows coil spirals up anticlockwise, (any spiral directions may be reversed).

Diagram 12 shows horizontal cross-section of Diagram 11. Diagram 12 part 1 shows the magnets and magnet arrangement. Diagram 12 part 2 shows the conduit carrying the ferrofluid or nanomagnetic particles. Diagram 12 part 3 shows the coil spiralling down with a wider diameter at the top looking down. Diagram 12 part 4 shows coil spiralling upward with a wider diameter at the bottom. The positioning of part 3 and 4 in Diagram 12 may be reversed.

Diagram 13 shows another embodiment of my invention and is a horizontal cross-section of my invention. Diagram 13 part 1 shows magnets or magnet arrangement. Diagram 13 part 2 shows the conduit carrying the ferrofluid or nanomagnetic particles woven around the magnetic cores. Diagram 13 part 3 shows the heat sink in the core of the magnets. Diagram 13 part 4 shows extra magnets placed outside the heat source. Diagram 13 part 5 shows positioning of the heat source next to the outside of the conduit carrying the ferrofluid or nanomagnetic particles.

### APPLICATIONS

Electric power generator, motors, energy harvester, power source for miniaturised technologies, micro electrical mechanical systems, nano electrical mechanical systems, energy sensor, power utilising waste heat.

What is claimed is:

1. An electric power generator comprising:
a shaped conduit wound around a magnetic core producing acceleration of magnetic dipoles of the ferrofluid or magnetic nanoparticles as they move through the conduit
a diamagnetic material placed within or outside of the conduit causing repulsion of magnetic dipoles
ferrofluid or nanoparticle magnetic fluid contained within the conduit for producing a magnetic flux within the conduit
a shaped magnet or magnet assembly or source for magnetising the fluid
a coil of insulated conducting wire surrounding the said conduit as part of the induction unit
a heat source and a heat sink creating a temperature differential in the magnetic ferrofluid or magnetic nanoparticle fluid
a conduit connected between the heat source and heat sink producing a temperature differential in the said conduit
conducting sleeves on both sides of the conduit to provide the temperature differential to the ferrofluid or magnetic nanoparticle fluid.

2. In accordance with claim 1 an electric power generator comprising:
The said conduit which in parts of the conduit may be shaped as a simple curved surface, a helicoid, a spiroid, a spheroid, a solenoid, a catenoid, a cylinder, a gnomic shape or a non-gnomic shape.

3. In accordance with claim 1 an electric power generator comprising:
The said conduit is hermetically sealed; said conduit is a closed circuit.

4. In accordance with claims 1 and 2 an electric power generator comprising:
The said shapes assist in the acceleration of the particles of the ferrofluid or nanomagnetic fluid.

5. In accordance with claim 1 an electric power generator comprising:
The said conduit is made of a non-conducting or conducting material or combination thereof in order to optimise the conduction within the conduit.

6. In accordance with claim 1 and claim 5 an electric power generator comprising:
The said conduit has a shaped cross-section which may be circular, elliptical or irregular.

7. In accordance with claims 1, 5 and 6 an electric power generator comprising:
The said conduit has a shaped cross-section that may vary in size along its length.

8. In accordance with claims 1, 5, 6 and 7 an electric power generator comprising:
The said conduit may be magnetic, non-magnetic, paramagnetic, diamagnetic or a combination thereof.

9. In accordance with claim 1 an electric power generator comprising:
The said diamagnetic material may be placed either continuously or intermittently along either surface of the conduit or in the space surrounding the conduit.

10. In accordance with claim 1 and 9 an electric power generator comprising:
The said diamagnetic material may be placed through the material of the conduit or through the space that the conduit encloses.

11. In accordance with claims 1, 8, 9, and 10 an electric power generator comprising:
The said diamagnetic material is positioned to optimise diamagnetic properties to influence the flow of ferrofluid or nanomagnetic fluid.

12. In accordance with claims 1, 8, 9, 10 and 11 an electric power generator comprising:
The said diamagnetic material may be placed as positioned particles throughout the material of which the conduit is made.

13. In accordance with claims 1, 8, 9, 10, 11 and 12 an electric power generator comprising:
The said positioned particles may be rotated on their axis to take advantage of the properties of the diamagnetic.

14. In accordance with claims 1, 11, 12, and 13 an electric power generator comprising:
The said positioned particles may vary in size from nanometres to metres.

15. In accordance with claims 1 and 2 an electric power generator comprising:
The said conduit housing the ferrofluid or nanomagnetic fluid may be gnomic-shaped, non-gnomic shaped, helicoidal, spiroidal, spheroidal, solenoidal or catenoidal in its placement around the magnetic core.

16. In accordance with claim 1 an electric power generator comprising:
The said magnet or magnet assembly or source for magnetising the fluid contains a core of heat-conducting material.

17. In accordance with claim 1 an electric power generator comprising:
The said magnet or magnet assembly or source for magnetising the fluid may be shaped: conically, cylindrically, spheroidally, spiroidally, catenoidally, gnomically or non-gnomically.

18. In accordance with claim 1 and claim 17 an electric power generator comprising:
The said magnet or magnet assembly or source for magnetising the fluid may be assembled with heat-conducting material to increase the rate of heat transfer and cool the conducting cone surrounding magnet or magnet assembly or source for magnetising the said ferrofluid or nanomagnetic particle fluid.

19. In accordance with claims 1, 17, and 18 an electric power generator comprising:
The said magnet or magnet assembly or source for magnetising the said fluid increases the motion of the magnetic dipoles within the said ferrofluid or nanomagnetic particle fluid and thereby increases the kinetic energy of the magnetised dipoles.

20. In accordance with claims 1, 17, 18 and 19 an electric power generator comprising:
The said shaped magnet or magnet assembly or source for magnetising is placed adjacent to the said conducting sleeve, which is placed adjacent to the inside bends of the conduit.

21. In accordance with claims 1, 17, 18, 19 and 20 an electric power generator comprising:
The said shaped magnet or magnet assembly or source for magnetising rests on a heat sink which draws heat from said magnet said magnet assembly or said source for magnetising.

22. In accordance with claims 1, 17, 18, 19, 20 and 21 an electric power generator comprising:
The said heat sink which draws heat from said source for magnetising contains an extension of the conducting cylinder which passes through the said magnet, magnet assembly or said source for magnetising.

23. In accordance with claims 1 and 22 an electric power generator comprising:
A conductor plate attached to the end of the said conducting cylinder and surrounded by the heat sink which is maintained at a cool temperature.

24. In accordance with claim 1 an electric power generator comprising:
The said conduit is wrapped with more than one insulated coil of conducting wire.

25. In accordance with claims 1 and 24 an electric power generator comprising:
The said coil of conducting wire follows the shape of the conduit both in configuration and thickness.

26. In accordance with claims 1, 24 and 25 an electric power generator comprising:
The said conducting wire surrounding the conduit may cover any length or portion thereof of the conduit.

27. In accordance with claims 1, 24, 25 and 26, an electric power generator comprising:
The said conducting wire surrounding the conduit may be of varying thickness.

28. In accordance with claim 1 an electric power generator comprising:
The said conduit is wrapped with a conductive membrane or embedded in a conductive encasement in the area close to the heat source.

29. In accordance with claim land 28 an electric power generator comprising:
The said conductive membrane or the said encasement is attached to or surrounded by the heat source.

30. In accordance with claims 1, 28 and 29 an electric power generator comprising:
The position of the heat sink and heat source may be reversed.

31. In accordance with claim 1 an electric power generator comprising:
The direction of the wrapping of the conduit may be clockwise or anticlockwise looking down on the invention.

32. In accordance with claim 1 an electric power generator comprising:
The magnet, magnet assembly or said source for magnetising is axially polarised.

33. In accordance with claims 1 and 32 an electric power generator comprising:
The polarity of the said magnet, magnet assembly or said source for magnetising may be reversed.

34. In accordance with claim 1 and 2 an electric power generator comprising:
The said coil takes the same shape of the said conduit as the said coil is wrapped around the conduit.

35. In accordance with claim 1 and claim 2 an electric power generator comprising:
The said conduit has a shaped cross-section which may be comprise of more than one magnetic core; the said conduit weaving between the magnetic cores; the said conduit descending or ascending around the out side of these cores; the said weaving creates change in acceleration forces affecting the spin of the dipoles of of the ferrofluid or magnetic nanoparticle fluid.

36. In accordance with claims 1, 22 and 23 an electric power generator comprising:
The said ferrofluid or magnetic particle nanofluid may travel up through the centre of the magnetic core which is part of the heat sink.

37. In accordance with claim 1 an electric power generator comprising:
The said conductor sleeve may be a solid plate, mesh or material.

38. In accordance with claims 1 and 37 an electric power generator comprising:
A conductor sleeve may be placed on the outside bends of the conduit; the said conductor sleeve may be placed on the inside bends of the conduit.

39. In accordance with claims 1, 37 and 38 electric power generator comprising:
The said conductor sleeve may be made of thermally conductive metal, thermally conductive material or thermally conductive mesh.

40. In accordance with claims 1 an electric power generator comprising:
The said heat source uses heat from the sun, atmosphere, water, man made materials or the earth.

41. In accordance with claims 1 an electric power generator comprising:
The said heat sink releases heat to the atmosphere, man made materials, the earth, ice, snow, bodies of water, man made materials or devices.

42. In accordance with claims 1 an electric power generator comprising:
The device has no solid moving mechanical parts and requires no external pump.

43. In accordance with claims 1 and 2 an electric power generator comprising:
spiral directions of the conduit may be reversed.

44. In accordance with claims 1 an electric power generator comprising:
The magnet or magnetic assembly or source for magnetising the fluid may have 1 or many magnets.
In view of the above it will be apparent that many modifications and variations may be made by those skilled in the art and it is intended that all such modifications be covered within the scope of the claims.
